(19) United States
(12) Patent Application Publication
(10) Pub. No.: US 2006/0036584 A1
(43) Pub. Date: Feb. 16, 2006

(54) Identification mark registration method, electronic apparatus and computer-readable storage medium

(75) Inventor: Miwako Isa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/981,644

(22) Filed: Nov. 5, 2004

(30) Foreign Application Priority Data
Aug. 10, 2004 (JP) 2004-233483

(51) Int. Cl. G06F 17/30

(52) U.S. Cl. 707/3

(57) ABSTRACT

An identification mark registration method obtains an identification mark which visually assists search of at least one element selected from accessible homepages, sites and folders, and registers the identification mark with respect to the one element in an electronic apparatus located at an access source.

### BACKGROUND OF THE INVENTION

This application claims the benefit of a Japanese Patent Application No. 2004-233483 filed Aug. 10, 2004, in the Japanese Patent Office, the disclosure of which is hereby incorporated by reference.

1. Field of the Invention

The present invention generally relates to identification mark registration methods, electronic apparatuses and computer-readable storage media, and more particularly to an identification mark registration method for registering an identification mark which visually assists search of accessible homepages, sites and folders, an electronic apparatus which employs such an identification mark registration method, and a computer-readable storage medium which stores a program for causing a computer to register an identification mark.

2. Description of the Related Art

Recently, it has become possible to make access to the Internet even from electronic apparatuses such as portable telephone sets and personal digital assistants (PDAs). Such electronic apparatuses are provided with a function of bookmarking universal resource locators (URLs) of homepages and sites, and the bookmarked URLs are displayed on a display part by names thereof or character information.

For example, a Japanese Laid-Open Patent Application No. 2003-67328 proposes a bookmark management system.

However, since the URL that is bookmarked in the conventional electronic apparatus is displayed on the display part by the name thereof or character information, it is difficult for the user to accurately recognize the kind or characteristics of the services provided at the URL or, particular images provided at the URL, unless the user remembers the name and contents of the URL. In addition, especially in the case of a portable electronic apparatus, the display part is relatively small, and for this reason, it is difficult to accurately recognize the name or character information displayed on the display part by taking a glance at the display part. Furthermore, similar problems were encountered in the case of a folder whose name or character information is displayed on the display part.

When searching for a bookmarked URL or a stored folder in the conventional electronic apparatus, the user's personal memory is relied on for an attribute that indicates the information or image to which the URL or folder relates. Consequently, it is difficult to quickly search the URL or folder having a desired attribute based on the user's memory.

### SUMMARY OF THE INVENTION

Accordingly, it is a general object of the present invention to provide a novel and useful identification mark registration method, electronic apparatus and computer-readable storage medium, in which the problems described above are suppressed.

Another and more specific object of the present invention is to provide an identification mark registration method, an electronic apparatus and a computer-readable storage medium, which enable easy recognition of accessible homepages, sites and folders, and also enable a quick search of homepages, sites and folders having desired attributes.

Still another object of the present invention is to provide an identification mark registration method, comprising obtaining an identification mark which visually assists search of at least one element selected from a group consisting of accessible homepages, sites and folders; and registering the identification mark with respect to the one element in an electronic apparatus located at an access source. According to the identification mark registration method of the present invention, it is possible to easily recognize accessible homepages, sites and folders, and make a quick search of homepages, sites and folders having desired attributes.

A further object of the present invention is to provide an electronic apparatus comprising an access part configured to make access to at least one element selected from a group consisting of homepages, sites and folders; and a registration part configured to register with respect to the one element an identification mark which visually assists search of the one element. According to the electronic apparatus of the present invention, it is possible to easily recognize accessible homepages, sites and folders, and make a quick search of homepages, sites and folders having desired attributes.

Another object of the present invention is to provide a computer-readable storage medium which stores a program for causing a computer to access at least one element selected from a group consisting of homepages, sites and folders, the program comprising an obtaining procedure causing the computer to obtain an identification mark which visually assists search of at least one element selected from a group consisting of accessible homepages, sites and folders; and a registration procedure causing the computer to register the identification mark with respect to the one element. According to the computer-readable storage medium of the present invention, it is possible to easily recognize accessible homepages, sites and folders, and make a quick search of homepages, sites and folders having desired attributes.

Still another object of the present invention is to provide an identification mark search method comprising selecting an identification mark from a group consisting of icons, color patterns and thumbnails; and searching at least one element selected from a group consisting of accessible homepages, sites and folders, based on the selected identification mark which is registered with respect to the one element and visually assists the search of the one element. According to the identification mark search method of the present invention, it is possible to easily recognize accessible homepages, sites and folders, and make a quick search of homepages, sites and folders having desired attributes.

Other objects and further features of the present invention will be apparent from the following detailed description when read in conjunction with the accompanying drawings.

### BRIEF DESCRIPTION OF THE DRAWINGS

FIG. 1 is a system block diagram showing an important part of an embodiment of an electronic apparatus according to the present invention;

FIG. 2 is a flow chart for explaining a first identification mark registration process of the embodiment;

FIG. 3 is a flow chart for explaining a first identification mark search process of the embodiment;

FIG. 4 is a flow chart for explaining a second identification mark registration process of the embodiment;

FIG. 5 is a diagram showing a thumbnail image;

FIG. 6 is a flow chart for explaining a third identification mark registration process of the embodiment;

FIG. 7 is a flow chart for explaining a fourth identification mark registration process of the embodiment; and

FIG. 8 is a flow chart for explaining the fourth identification mark registration process of the embodiment.

### DESCRIPTION OF THE PREFERRED EMBODIMENTS

In the present invention, an identification mark for visually assisting the search of at least one element selected from accessible homepages, sites and folders is registered in an electronic apparatus at the access source, such as a portable telephone set and a PDA, with respect to the element. Because the identification mark that is registered with respect to each element is selected and registered by the user of the electronic apparatus, it becomes possible to easily recognize the homepages, sites and folders, and to quickly search the homepages, sites and folders having desired attributes.

A description will now be given of embodiments of an identification mark registration method, an electronic apparatus and a computer-readable storage medium according to the present invention, by referring to the drawings.

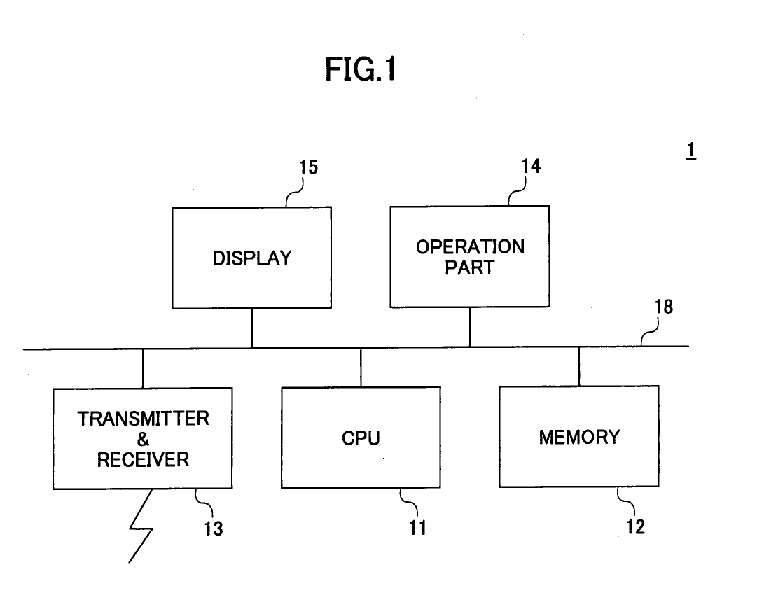

FIG. 1 is a system block diagram showing a structure of an important part of an embodiment of the electronic apparatus according to the present invention. In this embodiment, the present invention is applied to a portable telephone set for the sake of convenience, but the electronic apparatus is of course not limited to the portable telephone set. For example, the electronic apparatus includes various apparatuses connectable to the Internet, such as computers, PDAs and communication apparatuses. In addition, the electronic apparatus may be a setup type such as a desk-top computer or, a portable type such as a portable personal computer.

This embodiment of the electronic apparatus employs an embodiment of the identification mark registration method according to the present invention, and an embodiment of the computer-readable storage medium according to the present invention.

A portable telephone set 1 shown in FIG. 1 includes a CPU 11, a memory part 12, a transmitter and receiver part 13, an operation part 14 and a display part 15 which are connected via a bus 18. The CPU 11 controls the general operation of the entire portable telephone set 1. The memory part 12 may be formed by a semiconductor memory device. The memory part 12 stores computer programs to be executed by the CPU 11, and various data including intermediate data of operations carried out by the CPU 11 and icons which will be described later. The transmitter and receiver part 13 has a known structure for making transmissions and receptions via an antenna (not shown).

The operation part 14 has the plurality of operation keys that are operated (or manipulated) when the user inputs information to the portable telephone set 1. For example, the operation keys include numeric and/or character input keys (or alphanumeric keys), cursor moving keys, a determination (or execute) key and the like. The display part 15 displays various menus which will be described later, information input from the operation keys, and the like. The operation part 14 and the display part 15 may be provided integrally as in the case of a touch panel.

In this embodiment, the electronic apparatus makes a wireless communication. However, in a case where the electronic apparatus makes a cable communication, a transmitter and receiver part including an interface for connecting to a network may be provided in place of the transmitter and receiver part 13.

The computer programs stored in the memory part 12 include an identification mark registration program for making an identification mark registration, an identification mark search program for making an identification mark search, and the like. In this embodiment, a computer-readable storage medium which stores the identification mark registration program and the like is the semiconductor memory device forming the memory part 12. However, a storage medium forming the computer-readable storage medium is not limited to a particular type, and may be formed by any type of storage media capable of storing the key lock control program in a computer-readable manner. For example, the computer-readable storage medium may be formed by magnetic recording media, optical recording media and magneto-optic storage media. Furthermore, the computer program may be installed into the memory part 12 of the portable telephone set 1 via a wireless and/or a cable network.

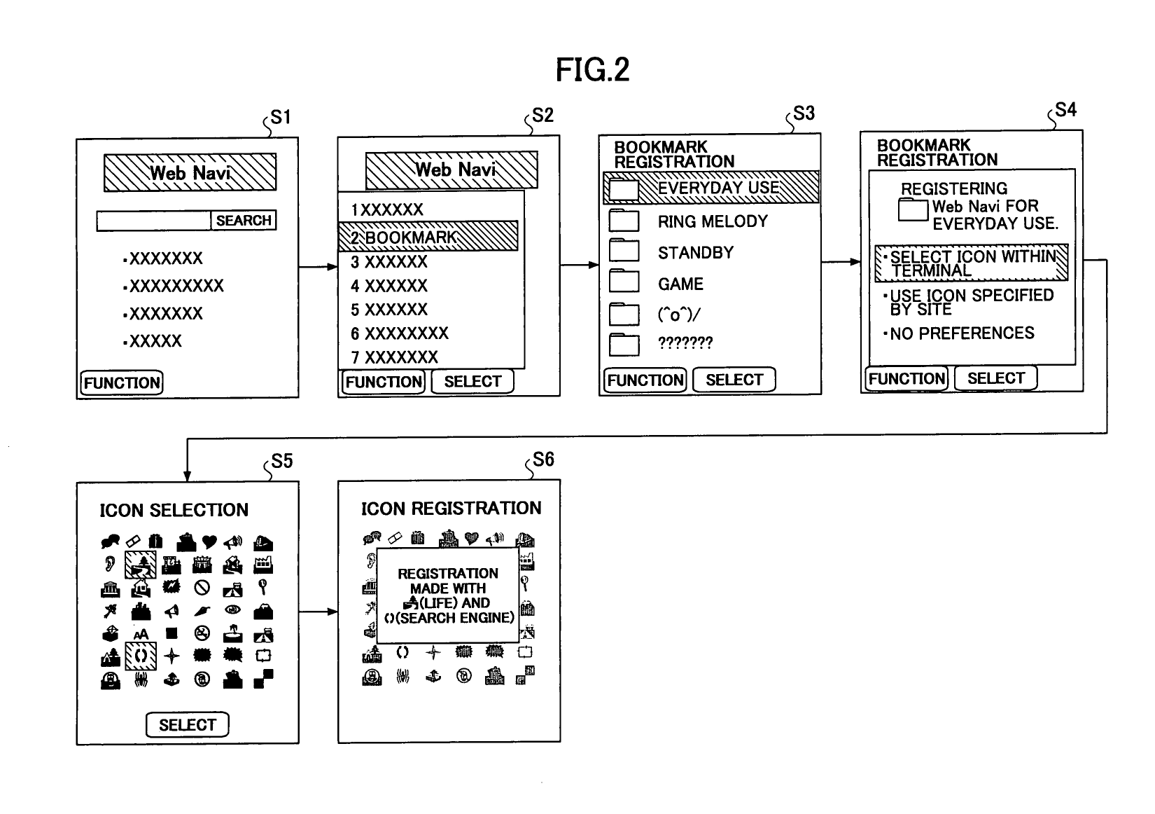

FIG. 2 is a flow chart for explaining a first identification mark registration process of this embodiment. The first identification mark registration process shown in FIG. 2 is carried out by the CPU 11. For the sake of convenience, FIG. 2 shows menus and information that are displayed on the display part 15 in various steps (or stages) of the first identification mark registration process.

In FIG. 2, a step S1 connects to the Internet by a known method in response to a key operation made by a user from the operation part 14, so as to make access to a homepage or a site. In this case, it is assumed for the sake of convenience that an access is made to a site “Web Navi” and this site is displayed on the display part 15. A step S2 displays a function selection sub-menu on the display part 15 in response to a key operation which selects “function” from the operation part 14. A step S3 displays a bookmark registration menu on the display part 15 when a function “bookmark” is selected on the function selection menu by a key operation of the operation part 14. Selectable folders of the bookmark and the folder names are displayed on the bookmark registration menu, so as to urge the user to select the folder of the bookmark. If a folder of the bookmark, having a name “everyday use”, is selected on the bookmark registration menu by a key operation which selects “selection” from the operation part 14, a step S4 displays the folder name of the selected folder of the bookmark and a menu urging the user to select an icon selection method, on the display part 15. In this embodiment, the icon selection method is selectable from “select icon within terminal”, “use icon specified by site” and “no preferences”. If the icon selection method “select icon within terminal” is selected, a desired icon is selectable from an icon list that is registered in the memory part 12 of the portable telephone set 1. If the icon selection method “use icon specified by site” is selected, the icon specified by the accessed homepage or site is selected by a known method, and thus, the bookmark is carried out similarly as in the case of the conventional procedure. If the icon selection method “no preferences” is selected, no icon selection is made, and thus, the bookmark is carried out similarly as in the case of the conventional procedure.

If the icon selection method “select icon within terminal” is selected by a key operation of the operation part 14 in the step S4, a step S5 displays the icon list registered in the memory part 12 on the display part 15. The icon list may be made up of default icons that are prestored in the memory part 12 or, be made up of icons that are created by the user and stored in the memory part 12. The icon list stored in the memory part 12 may be arbitrarily modifiable by a key operation of the operation part 14. If the user selects the desired icon by a key operation of the operation part 14, a step S6 registers the selected icon with respect to the site “Web Navi” and stores registration information in the memory part 12, and also displays on the display part 15 a message indicating that the selected icon has been registered with respect to the accessed homepage or site.

Therefore, according to the first identification mark registration process, the icon is used as an identification mark for visually assisting the search of the homepage or site. Although FIG. 2 shows a case where two icons are registered with respect to one site, the number of icons that are registered with respect to one homepage or site may be one or more than two.

Each icon is a picture indicating the attribute of the homepage or site. For this reason, when searching the icon (identification mark) at the time of a search which will be described later, it becomes possible to easily and visually search the desired homepage or site, mainly from the attribute of the icon, without relying solely on the character information or the name of the URL of the desired homepage or site. For example, in a case where the attribute of the homepage or site indicated by the icon is “search engine”, the icon may be a picture of an arrow indicating a search as shown in FIG. 2 or, a picture of a magnifying glass or a globe. In other words, the icon may be any picture, symbol or the like that can visually indicate the attribute of the homepage or site. Accordingly, the icons that are registered with respect to each of the homepages and/or sites may be managed based on the attributes. In the case shown in FIG. 2, the site “Web Navi” is bookmarked in the folder of the bookmark having the folder name “everyday use”, and an icon having an attribute “life” and an icon having an attribute “search engine” are registered with respect to the site “Web Navi”.

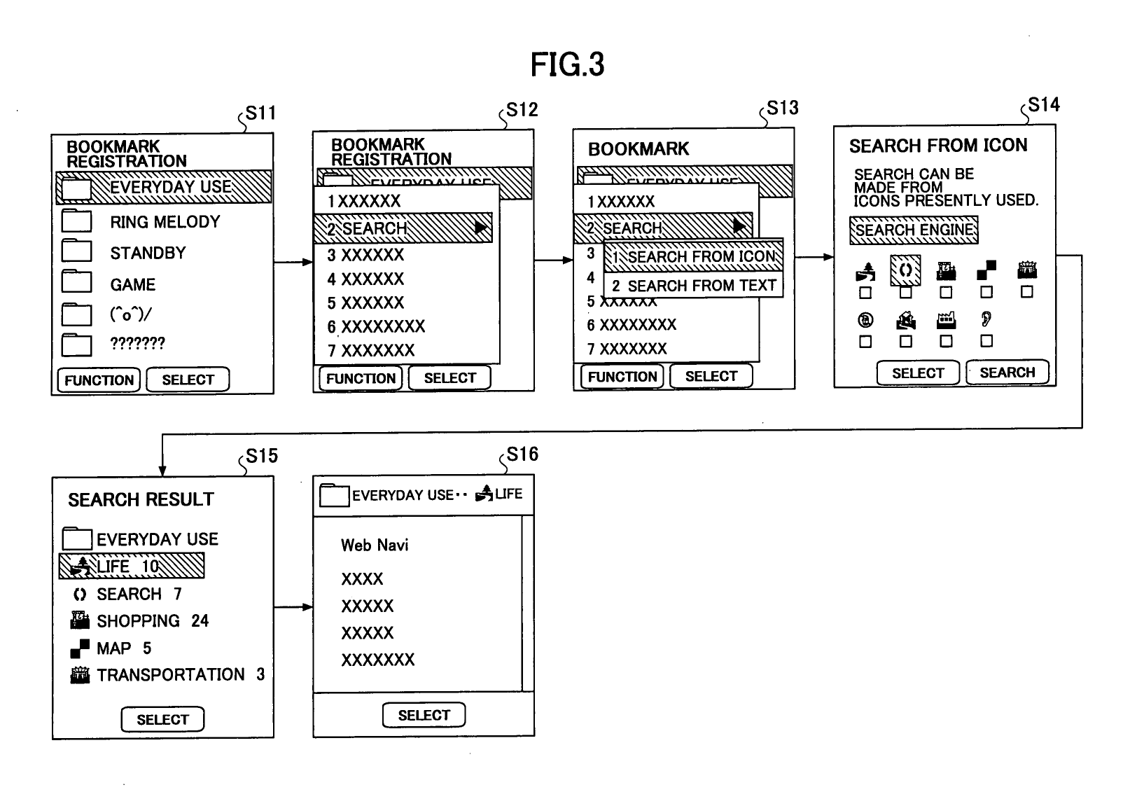

FIG. 3 is a flow chart for explaining a first identification mark search process of this embodiment for a case where the first identification mark registration process shown in FIG. 2 has been carried out. The first identification mark search process shown in FIG. 3 is carried out by the CPU 11. For the sake of convenience, FIG. 3 shows menus and information that are displayed on the display part 15 in various steps (or stages) of the first identification mark search process.

In FIG. 3, a step S11 displays a bookmark selection menu on the display part 15 in response to a key operation made by the user from the operation part 14. Suppose that the folder of the bookmark having the folder name “everyday use” is selected on the bookmark selection menu by a key operation which selects “select” from the operation part 14. After this selection is made, a step S12 displays a function selection sub-menu on the display part 15 in response to a key operation which selects “function” from the operation part 14. When a function “search” is selected on the function selection sub-menu by a key operation of the operation part 14, a step S13 displays a search selection sub-menu urging the user to select a search method for searching the homepages or sites that are registered within the selected folder of the bookmark, on the display part 15. In this embodiment, the search method is selectable from “search from icon” and “search from text”. When the search method “search from icon” is selected, the search for the homepage or site is made based on the iron. On the other hand, when the search method “search from text” is selected, the search for the homepage or site is made based on the text, that is, based on the character information and the name of the homepage or site, and the search is made similarly as in the case of the conventional procedure.

When the search method “search from icon” is selected on the search selection sub-menu by a key operation of the operation part 14, a step S14 displays on the display part 15 the icons that are presently used with respect to the selected folder of the bookmark, so as to urge the user to select the icons. For example, if the user selects icons having the attributes “life”, “search (engine)”, “shopping”, “map” and “transportation” by a key operation of the operation part 14, a step S15 displays a search result on the display part 15. In this case, with respect to the folder having the folder name “everyday use”, the search result indicates that there are 10 homepages and/or sites with the icons having the attribute “life”, 7 homepages and/or sites with the icons having the attribute “search (engine)”, 24 homepages and/or sites with the icons having the attribute “shopping”, 5 homepages and/or sites with the icons having the attribute “map”, and 3 homepages and/or sites with the icons having the attribute “transportation”. Two or more icons having different attributes may be registered with respect to the same homepage and/or site. If the user selects the icon having the attribute “life” on the displayed search result by a key operation of the operation part 14, for example, a step S16 displays on the display part 15 the character information and the name of each homepage and/or site registered with the icon having the attribute “life”. In order to make access to a desired one of the displayed homepages and/or sites, the user simply needs to select the desired homepage or site by a key operation of the operation part 14.

In a case where the search method “search from icon” is selected on the search selection sub-menu, a preset icon may be selected automatically instead of having the user to select the icon every time by a key operation of the operation part 14. The preset icon may be set as a default setting or, may be selected and set by the user. In addition, the user may finally select an icon by deleting and modifying icons within a group of preset icons.

Therefore, according to the first identification mark search process, it is possible to easily and visually search the desired homepage or site, mainly from the attribute of the icon, without relying solely on the character information or the name of the URL of the desired homepage or site. Moreover, since the search can be made based on the icon, it is possible to accurately make the search at a high speed compared to making the search based solely on the character information or the name of the URL of the desired homepage or site, particular in a case where the display part 15 is relatively small and a display area thereof is limited.

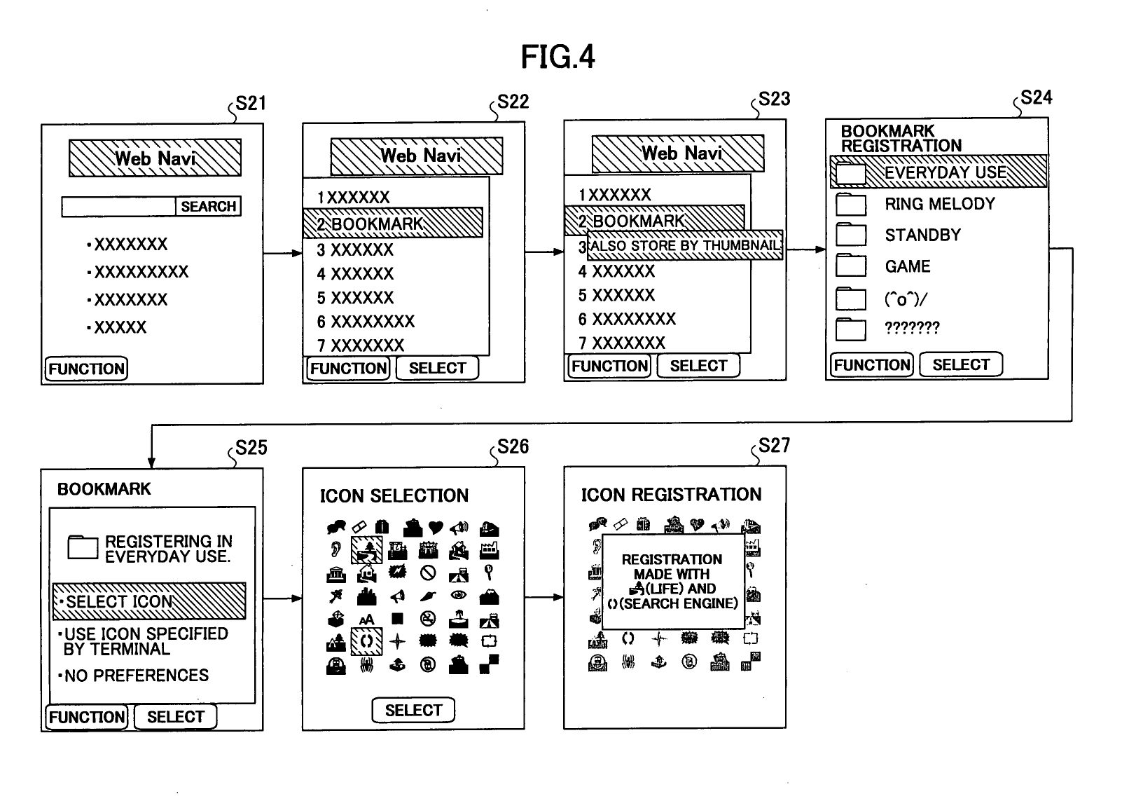

FIG. 4 is a flow chart for explaining a second identification mark registration process of this embodiment. The second identification mark registration process shown in FIG. 4 is carried out by the CPU 11. For the sake of convenience, FIG. 4 shows menus and information that are displayed on the display part 15 in various steps (or stages) of the second identification mark registration process.

In FIG. 4, a step S21 connects to the Internet by a known method in response to a key operation made by the user from the operation part 14, so as to make access to a homepage or a site. In this case, it is assumed for the sake of convenience that an access is made to a site “Web Navi” and this site is displayed on the display part 15. A step S22 displays a function selection sub-menu on the display part 15 in response to a key operation which selects “function” from the operation part 14. A step S23 displays a sub-menu for selecting “also store by thumbnail” on the display part 15 when a function “bookmark” is selected on the function selection menu by a key operation of the operation part 14 and the “function” is also selected by a key operation of the operation part 14. If “also store by thumbnail” is selected on the sub-menu by a key operation of the operation part 14, images of the site “Web Navi” are captured and formed into a thumbnail, and the thumbnail image is stored and registered in the memory part 12.

After the step S23, a step S24 displays a bookmark registration menu on the display part 15. Selectable folders of the bookmark and the folder names are displayed on the bookmark registration menu, so as to urge the user to select the folder of the bookmark. If a folder of the bookmark, having a name “everyday use”, is selected on the bookmark registration menu by a key operation which selects “selection” from the operation part 14, a step S25 displays the folder name of the selected folder of the bookmark and a menu urging the user to select an icon selection method, on the display part 15. In this embodiment, the icon selection method is selectable from “select icon within terminal”, “use icon specified by site” and “no preferences”. If the icon selection method “select icon within terminal” is selected, a desired icon is selectable from an icon list that is registered in the memory part 12 of the portable telephone set 1. If the icon selection method “use icon specified by site” is selected, the icon specified by the accessed homepage or site is selected by a known method, and thus, the bookmark is carried out similarly as in the case of the conventional procedure. If the icon selection method “no preferences” is selected, no icon selection is made, and thus, the bookmark is carried out similarly as in the case of the conventional procedure.

If the icon selection method “select icon within terminal” is selected by a key operation of the operation part 14 in the step S25, a step S26 displays the icon list registered in the memory part 12 on the display part 15. The icon list may be made up of default icons that are prestored in the memory part 12 or, be made up of icons that are created by the user and stored in the memory part 12. The icon list stored in the memory part 12 may be arbitrarily modifiable by a key operation of the operation part 14. If the user selects the desired icon by a key operation of the operation part 14, a step S27 registers the selected icon with respect to the site “Web Navi” and stores registration information in the memory part 12, and also displays on the display part 15 a message indicating that the selected icon has been registered with respect to the accessed homepage or site.

Therefore, according to the second identification mark registration process, the icon and the thumbnail are used as identification marks for visually assisting the search of the homepage or site. Although FIG. 4 shows a case where two icons are registered with respect to one site, the number of icons that are registered with respect to one homepage or site may be one or more than two.

Each icon is a picture indicating the attribute of the homepage or site. For this reason, when searching the icon (identification mark) at the time of a search which will be described later, it becomes possible to easily and visually search the desired homepage or site, mainly from the attribute of the icon, without relying solely on the character information or the name of the URL of the desired homepage or site. In the case shown in FIG. 4, the site “Web Navi” is bookmarked in the folder of the bookmark having the folder name “everyday use”, and an icon having an attribute “life” and an icon having an attribute “search engine” are registered with respect to the site “Web Navi”.

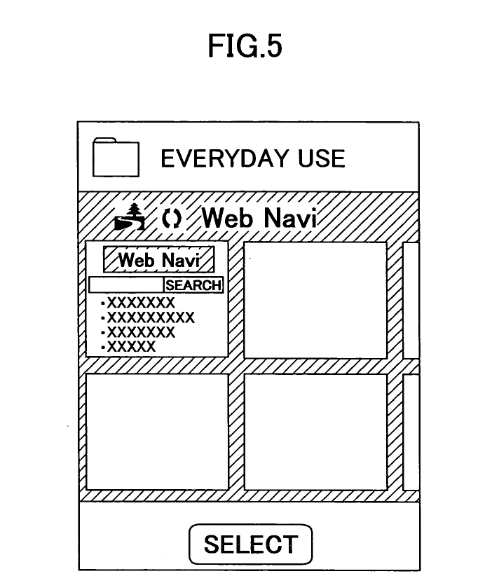

Next, a description will be given of a second identification mark search process of this embodiment for a case where the second identification mark registration process shown in FIG. 4 has been carried out. The second identification mark search process is basically the same as the first identification mark search process shown in FIG. 3. But when the icon having the attribute “life” is selected on the displayed search result by a key operation made by the user from the operation part 14, a step that is carried out in place of the step S16 shown in FIG. 3 displays on the display part 15 the thumbnails of the home pages and/or sites that are registered with the icons having the attribute “life” as shown in FIG. 5, with respect to the folder having the folder name “everyday use”. FIG. 5 is a diagram showing a thumbnail image, and only one thumbnail image is shown for the sake of convenience. In order to make access to a desired one of the displayed homepages and/or sites, the user simply needs to select the thumbnail of the desired homepage or site by a key operation of the operation part 14. The thumbnail image is not prepared by a provider of the homepage and/or site, but is obtained by capturing the image of the homepage or site that is bookmarked in the portable telephone set 1 forming the captured image into the thumbnail. For this reason, the user can easily confirm the contents and the attribute of the home page or site by simply looking at the thumbnail image. The effects of searching the homepage or site based on the thumbnail are substantially the same as the effects of search the homepage or site based on the icon.

When the user selects the icon having the attribute “life” on the displayed search result by a key operation of the operation part 14, for example, it is possible to make a mode selectable from a first mode and a second mode in response to a key operation of the operation part 14 that selects “select”, where the step S16 shown in FIG. 3 displays on the display part 15 the character information and the name of each homepage and/or site registered with the icon having the attribute “life” in the first mode and the thumbnails of the homepages and/or sites registered with the icon having the attribute “life” are displayed on the display part 15 as shown in FIG. 5 in the second mode.

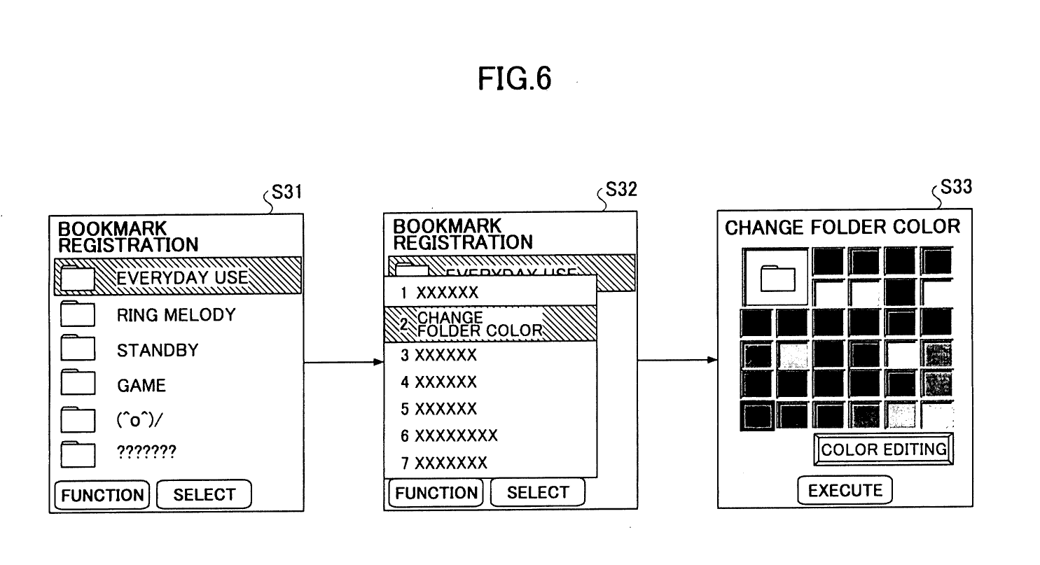

FIG. 6 is a flow chart for explaining a third identification mark registration process of this embodiment. The third identification mark registration process shown in FIG. 6 is carried out by the CPU 11. For the sake of convenience, FIG. 6 shows menus and information that are displayed on the display part 15 in various steps (or stages) of the third identification mark registration process.

In FIG. 6, a step S31 displays a bookmark registration menu on the display part 15 in response to a key operation made by the user from the operation part 14. Selectable folders of the bookmark and the folder names are displayed on the bookmark registration menu, so as to urge the user to select the folder of the bookmark. Suppose that a folder of the bookmark, having a name “everyday use”, is selected on the bookmark registration menu by a key operation which selects “selection” from the operation part 14. In this case, a step S32 displays a function selection sub-menu on the display part 15 in response to a key operation of the operation part 14 which selects “function”. If “change folder color” is selected on the function selection sub-menu in response to a key operation of the operation part 14, a step S33 displays folder color change menu on the display part 15. A desired color pattern is selectable on the folder color change menu from a color pattern list (or pallet) that is registered in the memory part 12 of the portable telephone set 1. Each color pattern is made up of one or a plurality of colors, and may include designs, patterns, markings, pictures and the like. When the user selects a desired color pattern of the icon which indicates the folder having the folder name “everyday use” by a key operation of the operation part 14 and selects “determination (or execute)” by a key operation of the operation part 14, the color pattern of the icon indicating this folder is changed to the desired color pattern.

The color pattern list may be made up of default color patterns that are prestored in the memory part 12 or, be made up of color patterns that are created by the user and stored in the memory part 12. The color pattern list stored in the memory part 12 may be arbitrarily modifiable by a key operation of the operation part 14.

Therefore, according to the third identification mark registration process, the color pattern of the folder is used as identification mark for visually assisting the search of the homepage or site. Since the user may arbitrarily set or modify the color pattern of each folder, it is possible to group the folders by the color patterns depending on the attributes and the like of the folders. It is also possible to manage the color patterns registered with respect to each of the folders based on the attributes. Hence, each folder may have a color pattern which indicates the attribute of the homepage or site, and when carrying out a corresponding third identification mark (or color pattern) search process, it becomes possible to easily and visually search the desired homepage or site, mainly from the color pattern of the folder, without relying solely on the character information or the name of the URL of the desired homepage or site.

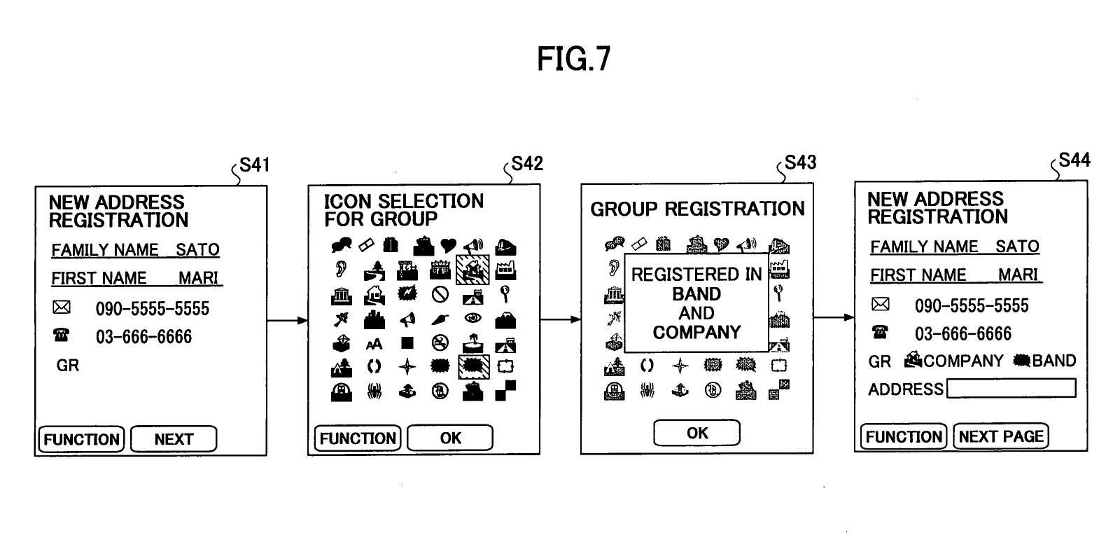

FIG. 7 is a flow chart for explaining a fourth identification mark registration process of this embodiment. The fourth identification mark registration process shown in FIG. 7 is carried out by the CPU 11. For the sake of convenience, FIG. 7 shows menus and information that are displayed on the display part 15 in various steps (or stages) of the fourth identification mark registration process. In the fourth identification mark registration process, the icon is used as an identification mark for visually assisting search of an address directory (or a telephone directory).

In FIG. 7, a step S41 makes an address registration by a known method in response to a key operation made by the user from the operation part 14, and displays a new address registration menu on the display part 15. The new address registration menu indicates address information that is registered by the address registration, such as first name, family name, electronic (e-mail) address and telephone number. When “group registration (GR)” is selected on the new address registration menu by a key operation of the operation part 14, a step S42 displays on the display part 15 an icon list that is registered in the memory part 12, so as to urge the user to select an icon with respect to a group to be registered. The icon list may be made up of default icons that are prestored in the memory part 12 or, be made up of icons that are created by the user and stored in the memory part 12. The icon list stored in the memory part 12 may be arbitrarily modifiable by a key operation of the operation part 14. If the user selects the desired icon by a key operation of the operation part 14, a step S43 registers the selected icon with respect to the address information and stores registration information in the memory part 12, and also displays on the display part 15 a message indicating that the selected icon has been registered with respect to the registered address information. FIG. 7 shows a case where ions having the attributes “company” and “band” are registered with respect to the address information. A step S44 displays on the display part 15 a new address registration menu which indicates the registered address information and the registered icons.

Therefore, according to the fourth identification mark registration process, the icon is used as an identification mark for visually assisting the search of the address directory (or telephone directory). Although FIG. 7 shows a case where two icons are registered with respect to one address information, the number of icons that are registered with respect to one address information may be one or more than two.

Each icon is a picture indicating the attribute of the address information. For this reason, when searching the icon (identification mark) at the time of a search which will be described later, it becomes possible to easily and visually search the desired address information, mainly from the attribute of the icon, without relying solely on the character information or the name of the address information.

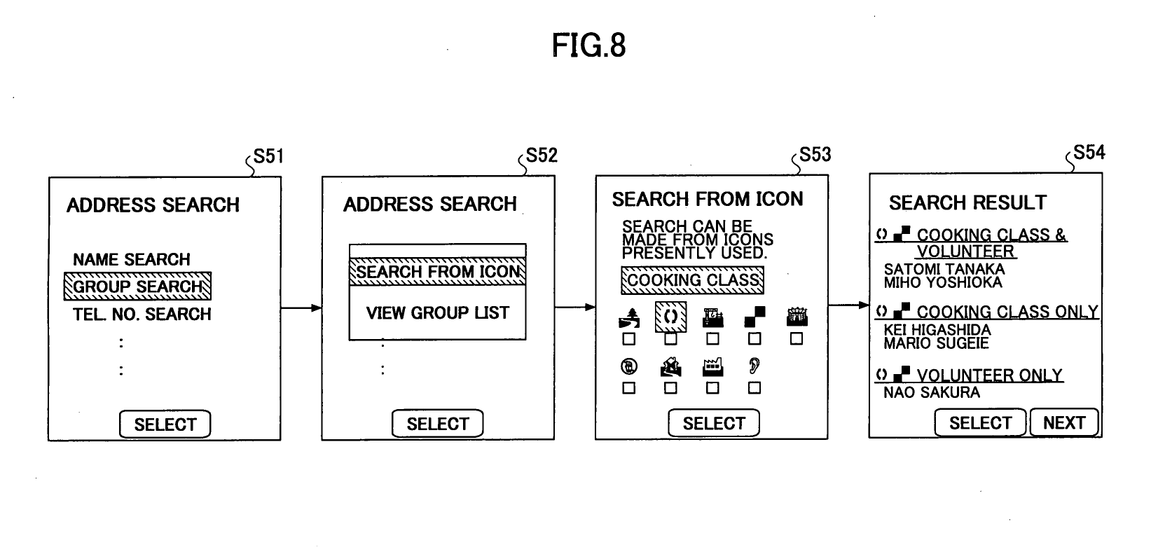

FIG. 8 is a flow chart for explaining a fourth identification mark search process of this embodiment for a case where the fourth identification mark registration process shown in FIG. 7 has been carried out. The fourth identification mark search process shown in FIG. 8 is carried out by the CPU 11. For the sake of convenience, FIG. 8 shows menus and information that are displayed on the display part 15 in various steps (or stages) of the fourth identification mark search process.

In FIG. 8, a step S51 displays on the display part 15 an address search menu in response to a key operation of the operation part 14. It is assumed for the sake of convenience that the address search is selectable from “name search” that is made based on the name, “group search” that is made based on the group, and “telephone number search” that is made based on the telephone number. When the “name search” or “telephone number search” is selected, the address search is carried out similarly as in the case of the conventional procedure. On the other hand, when the “group search” is selected by a key operation of the operation part 14, a step S52 displays on the display part 15 a sub-menu urging the user to select a group search method. In this embodiment, the group search method is selectable from “search from icon” and “view group list”. When the group search method “view group list” is selected, a group list is displayed on the display part 15 similarly as in the case of the conventional procedure.

When the group search method “search from icon” is selected by a key operation of the operation part 14, a step S53 displays icons that are presently used with respect to the folder of the selected address directory, so as to urge the user to select the icons. For example, if the user selects icons having the attributes “cooking class” and “volunteer” by a key operation of the operation part 14, a step S54 displays a search result on the display part 15. In this case, the search result indicates that 2 address information (Satomi Tanaka, Miho Yoshioka) registered with two icons having the attributes “cooking class & volunteer”, 2 address information (Kei Higashida, Mario Sugeie) registered with only one icon having the attribute “cooking class”, and 1 address information (Nao Sakura) registered with only one icon having the attribute “volunteer”. Hence, the search result also indicates the address information registered with a plurality of icons, to facilitate the search of the address information having the attributes desired by the user.

Therefore, according to the fourth identification mark search process, it is possible to easily and visually search the desired address information, mainly from the attribute of the icon, without relying solely on the character information or the name of the desired address information. Moreover, since the search can be made based on the icon, it is possible to accurately make the search at a high speed compared to making the search based solely on the character information or the name of the desired address information, particular in a case where the display part 15 is relatively small and a display area thereof is limited.

With respect to the folder of the address directory (or telephone directory), it is possible to carry out a process similar to the third identification mark registration process shown in FIG. 6, so as to utilize the color pattern of the folder as an identification mark for visually assisting the search of the address information. In this case, since the user may arbitrarily set or modify the color pattern of each folder, it is possible to group the folders by the color patterns depending on the attributes and the like of the folders. Hence, each folder may have a color pattern which indicates the attribute of the address information, and when carrying out the corresponding identification mark (or color pattern) search process, it becomes possible to easily and visually search the desired address information, mainly from the color pattern of the folder, without relying solely on the character information or the name of the desired address information.

The icons and the color patterns may be created by the user at the portable telephone set 1 and added to the corresponding icon list and color pattern list. Alternatively, the icons and color patterns may be acquired from another electronic apparatus such as a server via a network, and added to the corresponding icon list and color pattern list. In addition, the icon list itself and the color pattern list itself may also be acquired via the network.

The program stored in the computer-readable storage medium of the present invention, namely, the identification mark registration program and/or the identification mark search program, may of course be preinstalled in the electronic apparatus such as the portable telephone set 1 as an extension function or an application programming interface (API) of a browser software.

Further, the present invention is not limited to these embodiments, but various variations and modifications may be made without departing from the scope of the present invention.

What is claimed is:

1. An identification mark registration method, comprising:
obtaining an identification mark which visually assists search of at least one element selected from a group consisting of accessible homepages, sites and folders; and
registering the identification mark with respect to said one element in an electronic apparatus located at an access source.

2. The identification mark registration method as claimed in claim 1, wherein said obtaining selects the identification mark from a plurality of icons and/or a plurality of color patterns that are registered in advance within the electronic apparatus.

3. The identification mark registration method as claimed in claim 1, further comprising:
registering a plurality of thumbnail images by forming a thumbnail of each homepage or site that has been accessed from the electronic apparatus by capturing an image of the accessed homepage or site,
wherein said obtaining selects the identification mark from the registered thumbnail images.

4. The identification mark registration method as claimed in claim 2, wherein said obtaining selects a plurality of identification marks with respect to said one element.

5. The identification mark registration method as claimed in claim 1, wherein the identification mark indicates an attribute of said one element that corresponds thereto.

6. An electronic apparatus comprising:
an access part configured to make access to at least one element selected from a group consisting of homepages, sites and folders; and
a registration part configured to register with respect to said one element an identification mark which visually assists search of said one element.

7. The electronic apparatus as claimed in claim 6, further comprising:
a memory part configured to register a plurality of icons and/or a plurality of color patterns; and
a selecting part configured to select the identification mark from the plurality of icons and/or the plurality of color patterns that are registered in the memory part.

8. The electronic apparatus as claimed in claim 6, wherein the registration part registers, in the memory part, a plurality of thumbnail images by forming a thumbnail of each homepage or site that has been accessed from the electronic apparatus by capturing an image of the accessed homepage or site, and further comprising:
a selecting part configured to select the identification mark from the thumbnail images that are registered in the memory part.

9. The electronic apparatus as claimed in claim 6, wherein the identification mark indicates an attribute of said one element that corresponds thereto.

10. The electronic apparatus as claimed in claim 9, further comprising:
a managing part configured to manage identification marks that are registered in the memory part with respect to each element based on the attribute.

11. A computer-readable storage medium which stores a program for causing a computer to access at least one element selected from a group consisting of homepages, sites and folders, said program comprising:
an obtaining procedure causing the computer to obtain an identification mark which visually assists search of at least one element selected from a group consisting of accessible homepages, sites and folders; and
a registration procedure causing the computer to register the identification mark with respect to said one element.

12. The computer-readable storage medium as claimed in claim 11, wherein said obtaining procedure causes the computer to select the identification mark from a plurality of icons and/or a plurality of color patterns that are registered in advance.

13. The computer-readable storage medium as claimed in claim 11, wherein said program further comprises:
a procedure causing the computer to register a plurality of thumbnail images by forming a thumbnail of each homepage or site that has been accessed by capturing an image of the accessed homepage or site,
wherein said obtaining procedure causes the computer to select the identification mark from the registered thumbnail images.

14. The computer-readable storage medium as claimed in claim 12, wherein said obtaining procedure causes the computer to select a plurality of identification marks with respect to said one element.

15. The computer-readable storage medium as claimed in claim 11, wherein the identification mark indicates an attribute of said one element that corresponds thereto.

16. The computer-readable storage medium as claimed in claim 15, further comprising:
a managing procedure causing the computer to manage identification marks that are registered in the memory part with respect to each element based on the attribute.

17. An identification mark search method comprising:
selecting an identification mark from a group consisting of icons, color patterns and thumbnails; and
searching at least one element selected from a group consisting of accessible homepages, sites and folders, based on the selected identification mark which is registered with respect to said one element and visually assists the search of said one element.
